(19) United States
(12) Patent Application Publication
(10) Pub. No.: US 2021/0084000 A1
(43) Pub. Date: Mar. 18, 2021

(54) SYSTEMS AND METHODS FOR LOCATION-BASED MESSAGING

(71) Applicants: John Brogan, Kaukauna, WI (US); Gregory Vande Hey, Kaukauna, WI (US)

(72) Inventors: John Brogan, Kaukauna, WI (US); Gregory Vande Hey, Kaukauna, WI (US)

(21) Appl. No.: 17/108,413

(22) Filed: Dec. 1, 2020

Related U.S. Application Data
(63) Continuation of application No. 16/035,119, filed on Jul. 13, 2018, now abandoned.

(51) Int. Cl. H04L 12/58; H04W 4/02; G06F 21/62

(52) U.S. Cl. CPC H04L 51/20; G06F 21/629; H04W 4/025; H04L 51/10

(57) ABSTRACT

A location-based digital communication platform, whereby users may digitally interact with one another based, at least in part, on the users' physical locations in the real world. For example, a user may have the ability to associate a digital message with a particular geographic location. In this way, other users who may be at or near that same geographic location, or who may later travel to the geographic location, may have the ability to view or access the digital message. In some embodiments, access controls may allow a user to control which users have access to the message, the size of the area in which the message is available, and/or the length of time for which the message is available.

### FIELD OF THE INVENTION

The present disclosure relates to novel and advantageous electronic communication systems and methods. Particularly, the present disclosure relates to systems and methods for facilitating location-based digital or electronic communication among users. More particularly, the present disclosure relates to systems and methods for associating a digital or electronic message with a geographic location, such that users may access the message when located at or near the geographic location.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Modern technological devices and social media platforms generally allow individuals to communicate with one another from generally any location. Individuals on opposite sides of the world can send text messages and emails to one another. Similarly, an individual can create a social media post visible to others across the globe. However, there are some situations where an individual may wish to connect a message to a particular location, such that friends, family members, or other designated individuals may receive the note upon reaching the location. In these situations, text messaging, emailing, social media, and similar forms of remote technological communicate may not be particularly suitable.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for facilitating location-based electronic communication among users. The method may include receiving, from a user's device, a digital message authored by the user. The method may additionally include associating the digital message with a geographic location, such that the message is accessible only by users who are located at or near the geographic location. Moreover, the method may include determining at least one access control parameter for the message, such as an access area, an intended recipient, an intended group of recipients, a message duration, or a message expiration. In some embodiments, the method may include controlling access to the message by comparing user attributes to the one or more access control parameters. The method may include determining the user's current geographic location, which may be determined based on a GPS location of the user's device. In some embodiments, the geographic location associated with the message may be the user's current location. Moreover, the method may include determining whether there are available messages associated with locations at or near the user's current geographic location and, if there are available messages, displaying icons for the available messages. Where the user selects an icon for an available message, the method may include providing access to content of the message. Displaying icons for the available messages may include displaying the icons on a digital map. In some embodiments, the method may include providing a means for authoring a message. Moreover, determining an access control parameter for a message may include receiving the user's selection of an access control parameter.

The present disclosure, in one or more embodiments, additionally relates to a system for facilitating location-based communication among users. The system may include a plurality of user devices, each user device associated with a user, and a communication platform communicably coupled to the plurality of user devices over a wireless network. The communication platform may include a messaging module receiving messages authored by users. The communication platform may additionally include a mapping module determining, for each device, a current geographic location, and when a message authored by a user is received, associating that message with the current geographic location of the user's device, such that the message is accessible only by users who are located at or near the geographic location. The communication platform may additionally have an access control module controlling access to messages by applying stored access control parameters. In some embodiments, the system may have a remote database communicably coupled to the communication platform and storing messages, user data, access control parameters, and mapping data as non-transitory computer readable media. In some embodiments, the messaging module may provide a means for authoring a message on the plurality of user devices. Moreover, the mapping module may provide a digital map of the geographic area surrounding the user's current location, and the map may be accessible via the plurality of user devices. In some embodiments, the access control parameters corresponding to a message may be selected by the user who authored the message. Moreover, a stored access control parameter may be an access area for a message, an intended recipient or groups of recipients, or a message duration or expiration.

The present disclosure, in one or more embodiments, additionally relates to a method of using a location-based communication platform. The method may include, with a user device, creating a digital message having text, images, and/or audio. The method may additionally include associating the digital message with a geographic location, such that the message may be accessible only by users who are located at or near the geographic location. Moreover, the method may include selecting an access control parameter for the message, the access control parameter include an access area, an intended recipient or groups of recipients, and/or a message duration or expiration. In some embodiments, associating the digital message with a geographic location may include viewing a digital map of a geographic area surrounding a current location of the user device, and selecting a location on the map to associate with the digital message. The geographic location may be at or near the current location of the user device in some embodiments. In other embodiments, however, the geographic location may be remote from the current location of the user device. In some embodiments, the method may include accessing an available message authored by a different user by viewing a digital map of a geographic area surrounding a current location of the user device, and selecting an icon indicating the availability of the message.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a flow diagram of a method of facilitating location-based electronic communication, according to one or more embodiments.

FIG. 2 is a flow diagram of another method of facilitating location-based electronic communication, according to one or more embodiments.

FIG. 3 is a schematic diagram of a location-based electronic communication system of the present disclosure, according to one or more embodiments.

FIG. 4 is a flow diagram of a method of using a location-based electronic system of the present disclosure, according to one or more embodiments.

### DETAILED DESCRIPTION

Systems and methods of the present disclosure may provide a location-based digital communication platform, whereby users may digitally interact with one another based, at least in part, on the users' physical locations in the real world. For example, a user may have the ability to associate a digital message, or other communications or information, with a particular geographic location. In this way, other users who may be at or near that same geographic location, or who may later travel to the geographic location, may have the ability to view or access the digital message. In some embodiments, access controls may allow a user to control which users have access to the message, the size of the area in which the message is available, and/or the length of time for which the message is available. In this way, users may leave digital notes at particular geographic locations for friends or family, for example. Additionally or alternatively, a user may post a publicly accessible message at a particular geographic location.

In some embodiments, systems and methods of the present disclose may provide users with a digital map or map overlay through which users may post and access digital messages associated with geographic locations. For example, the system may present a user with a geographic map of the area at or near the user's current location. The geographic map may show landmarks, streets, addresses, and points of interest. The geographic map may additionally display an icon or indicator indicating the user's current location on the map. Moreover, the geographic map may display bubbles, circles, or other icons or indicators indicating the locations of available messages on the map. In some embodiments, a user may access available messages by selecting, tapping, or clicking on the message icons or indicators. Additionally, a user may select a location on the map for posting a digital message associated with that location. However, it is to be appreciated that in some embodiments, systems and methods of the present disclosure may a location-based communication platform without providing a digital map or map overlay.

Upon posting a message, access controls may allow a user to control how widely a message is distributed. For example, access controls may allow a user to specify particular individuals or groups of individuals with permission to access the message. Additionally, access controls may allow a user to specify a location size of the geographic area in which the message is accessible. For example, a user may designate that a message may be accessible within a particular 5-foot radius, within a particular 1-mile radius, or within an entire city. Other access controls may allow a user to specify message timing. For example a user may designate an expiration or duration time for a message, or other timing limitations. In some embodiments, a user may designate a message as active or dormant, which may control how other users access the message.

As a particular application for location-based communication systems and methods of the present disclosure, a user may leave a digital note for family members or housemates, associated with the geographic location of a shared home. The user may designate that the message is only viewable or accessible by particular users, or by a particular group of users. The user may associate the message with the geographic location of the shared home, and may additionally limit the message size to a relatively small area, such as a 10-foot radius or a smaller area, such that the message may only be accessible by a user who is inside or near the home. In this way, the digital note may be left securely, and family members or housemates may easily find and access the message upon arriving home. Moreover, in some embodiments, the user who left the digital note may receive a notification or other indication when the digital note has been accessed or viewed by other users.

Another example application for the location-based communication systems and methods described herein may relate to digital messages associated with physical doorsteps. For example, a salesperson or an individual campaigning or canvassing door-to-door may associate a digital message with a homeowner's physical doorstep to leave information for the residents of that particular home. Similarly, a delivery person may leave a digital “sorry we missed you” note associated with a resident's doorstep, rather than a physical note, when attempting to deliver a package.

Yet another example application for the location-based communication systems and methods described herein may relate to historical landmarks or other educational or informational purposes. As one example, digital messages detailing information about deceased climbers may be associated with individual locations along Mount Everest where those climbers perished. As another example, digital messages may be associated with individual art installations or artworks at a museum. Digital messages may be associated with civil war battle sites, and other historical locations, monuments, or points of interest as well. These digital messages may include educational and historical information for visitors of the site, such that visitors may access the information upon reaching or nearing the site.

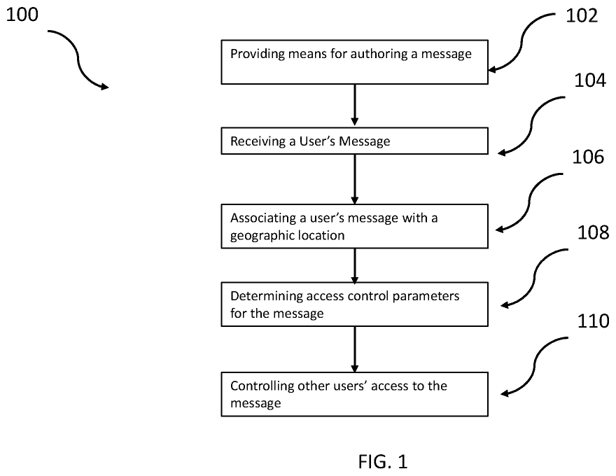

Turning now to FIG. 1, a method 100 of providing a location-based communication platform of the present disclosure is shown. The platform may be provided as, or through, a user interface, such as a software program or application. For example, a mobile application may allow a user to access the platform via a smartphone, smart watch, or other personal mobile device. Additionally or alternatively, a program or application may allow a user to access the platform via a desktop computer, notebook computer, or tablet computer. In some embodiments, the platform may be a web-based platform, accessible on an Internet-connected device. The method 100 may generally include the steps of providing a means for authoring a message 102; receiving a user's message 104; associating a user's message with a geographic location 106; determining access control parameters for the message 108; and controlling other users' access to the message 110. In other embodiments, the method 100 may include additional or alternative steps.

Providing a means for authoring a message 102 may include providing a user with the ability to enter or type a text message, record an audio message, record a video message, capture an image, or otherwise author content. In some embodiments, the message authoring means may additionally or alternatively allow a user to attach previously created content, such as by attaching a photo, video, text, or other content previously created or created using another application, program, or device. In some embodiments, the means may include one or more user interfaces, screens, fields, buttons, tabs, prompts, and/or other suitable elements. In some embodiments, the message authoring means may be configured to access the functionality of communicably coupled hardware, such as the camera and/or microphone of a smartphone. Similarly, the message authoring means may be configured to access other functionality of a device, such as a digital keyboard of a smartphone. In some embodiments, a message authoring means may limit the message in size or length, or may impose other limitations on the message, such as the type of content, for example.

In some embodiments, receiving a user's message 104 may include receiving content entered or authored by the user via the message authoring means. In other embodiments, a user's message or content may be received directly or indirectly in other ways or using other means.

A user's message may be associated with a geographic location 106. In some embodiments, the location may be a current geographic location of the user. For example, the user's current location, or approximate location, may be determined by geo-locating means, such as using a Global Positioning System (GPS) location of the user's device. In some embodiments, the user may enter or select the user's current location. In still other embodiments, the user may select a different location to associate with the message. For example, the user may have the ability to select a nearby location, to select a location of a friend or family member, or to enter a known address or other location. In some embodiments, a location selection means may be provided. For example, a digital map view may allow a user to select a location on the map. In some embodiments, a location may be a building, address, landmark, a point of interest, city, state, county, country, or a latitude and longitude. Still other methods and systems for establishing a geographic location may be provided.

In some embodiments, the method may include establishing access control permissions for the message 108. That is, other users' access to the message may be controlled or limited based upon those users' location, identity, status, or other attributes. Access controls may be determined automatically, or may be determined or adjusted by the message authoring user. In some embodiments, access controls may be determined automatically or may be determined based on default settings, or based on preferences of the message authoring user. Access controls may determine (1) which users can view that a message is associated with a location, and (2) which users can access the content of the message. In some embodiments, these two groups may be the same group of users. However, in other embodiments, some users may have the ability to view that a message is associated with a location, but access controls may prevent or limit that user's ability to access the content of the message.

In some embodiments, an access control may be based on user location. That is, and as generally described above, a message associated with a particular location may only be available to, accessible by, or visible to, other users who are at or near that location. In some embodiments, a message associated with a location may have an access area defining the geographic radius or limits within which the digital message may be accessible. For example, an access area may have a radius measured in feet, yards, miles, or other units. In some embodiments, a user may have the ability to select or adjust an access area. For example, if a message has an access area with a 5-foot radius, other users may generally only access that message when in or near the 5-foot radius of the location associated with the message. Other messages may have an access area defined by the nature of the particular location. For example, a message associated with a recreational park may have an access size defined by the geographic limits of the park, such that the message may generally only be accessible by users who are at or near the park. As another example, a message associated with a particular city may have an access area defined by the geographical limits of that city, such that the message may generally only be accessible by users who are within or near the city limits. Generally, users outside of an access area for a particular message may be unable to access or view the message. In some embodiments, users outside the access area may have the ability to view that a message has been associated with the location, but may not be able to access the content of the message until the user reaches the access area of the message.

Another access control may be based on user identity. In this way, a digital message may be designated such that only particular users, types of users, groups of users, or users with other particular identifying parameters may be permitted to view or access the message. For example, a message authoring user may leave a digital message at a geographic location for a particular user, such that the message is generally only accessible or viewable by that user. As another example, a message authoring user may designate that a message is to be accessible or viewable by all of the author's friends or contacts, or a portion thereof. In some embodiments, a message may be accessible or viewable only by users who are members of a particular group or community. Other user attributes may be used to dictate access permissions as well. One particular method of identifying a user may be based upon the user's phone number. For example, a message authoring user may indicate that a user associated with a particular phone number may have access to the message.

Another access control may be based on timing. For example, in some embodiments, messages may expire, such that the message is generally only available or accessible to users before the message expires. For example, a message authoring user may have the ability to set a duration of one hour, or any other suitable duration, after which the message may become inaccessible or unavailable to other users. In still other embodiments, other access controls may be provided for controlling access to messages as well. In some embodiments, systems limits may be imposed to control how long a message is available for viewing. In other embodiments, messages may evaporate or be deleted after viewing by another.

Based on the determined access controls, other users' access to the message may be controlled or limited 110. Controlling or limiting access to a message may include comparing a particular user's location, identity, or other parameters with access control permissions for that message. For example, if an access control permission for a message requires that the message is only accessible to friends of the message authoring user, user data may be analyzed to determine if a particular user is a designated friend and therefore should have access to the message. Additionally, users' location data may be compared to access controls to determine if and when the users are within range to access a message. Other user data or user parameters may be compared to access control permissions as well. If it is determined that a user has permission to access a message, the user may be permitted to open the message and view the message content. However, if it is determined that a user does not have permission to access a message due to one or more access controls, the user may not be permitted to view the message content.

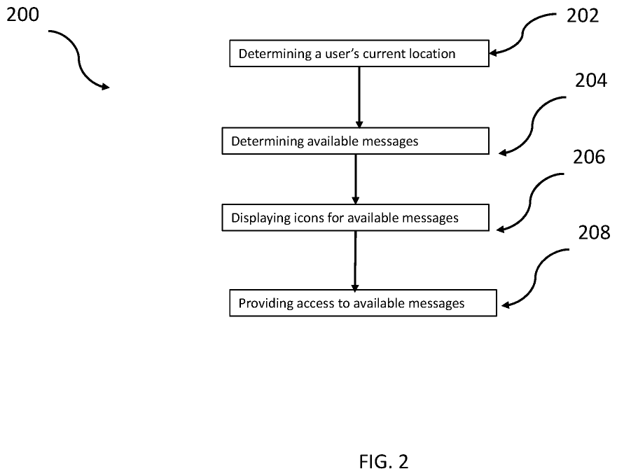

FIG. 2 illustrates another method 200 for providing a location-based communication platform of the present disclosure. The method may generally include the steps of determining a user's current location 202; determining available messages 204; displaying icons for available messages 206; and providing access to available messages 208. In other embodiments, the method 200 may include additional or alternative steps.

In some embodiments, determining a user's current location 202 may include receiving GPS coordinates of a user's current location. For example, GPS coordinates or geo-locating data associated with the user's smartphone or other device may be received. In other embodiments, the user's current location may be determined based on the user's own selection or indication of the user's current location. A user's location may be determined or tracked continuously, regularly, intermittently, at intervals, or on demand.

The method may additionally include determining whether there are available messages at or near the user's current location 204. That is, where a user is at a particular location, it may be determined whether other users have associated messages with that location. For example, if a user is in a public park, it may be determined whether there are digital messages associated with that public park. In some embodiments, it may also be determined whether there are messages near the user's current location, such that the user could choose to travel to access the nearby message(s).

Additionally, determining whether there are available messages at or near the user's location may include a consideration of any access controls associated with those messages. For example, based on the user's identity or affiliation with a group, the user may not have permission to access some messages at or near the user's current location. As a particular example, there may be messages at the user's current location that are intended for other individuals. The user may not have permission to access or view these messages, and thus they would not be available to this user.

If there are available messages at or near the user's current location, icons corresponding to those messages may be displayed to the user 206. For example, in some embodiments, icons or identifiers for available messages may be displayed on a map or map overlay, with a bubble, circle, or other indicator or icon indicating an available message. In other embodiments, indicators or icons for available messages may be displayed in an augmented or virtual reality view, such that a user may move or aim the device in different directions to view nearby available messages. In other embodiments, available messages at or near the user's current location may be displayed as a list. In still other embodiments, available messages may be displayed using other means or methods. In some embodiments, a user may receive push notifications, popup windows, or other notifications indicating that one or more messages is available at or near the user's current location.

The method may include providing access to messages at or near the user's current location 208. For example, where available messages are displayed as indicators over a map or in a map view, the user may select a message indicator on the map to access the text, image, video, audio, or other content of the message. In some embodiments, while a user may have the ability to view nearby messages, the user may only be able to access the content of messages associated with the user's current location. Thus, the user may be required to travel to access the content of nearby messages.

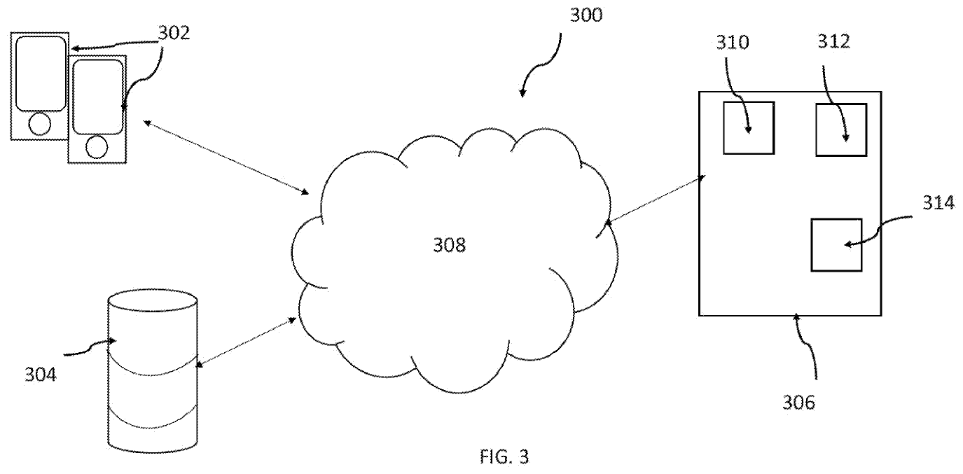

Turning now to FIG. 3, a location-based communication system 300 of the present disclosure is shown, according to one or more embodiments. The system may generally include one or more user devices 302, a database 304, and a communication platform 306 communicating over a wired or wireless network 308. In other embodiments, the system 300 may include additional or alternative components as well.

Each user device 302 may allow a user to access the communication platform via a user interface. Some user devices 302 may be a smartphones, smart watches, or other personal mobile devices. Another user device 302 may be a desktop computer, notebook computer, tablet computer, or other computing device. In some embodiments, a user device 302 may be equipped with software and/or hardware for geolocation. For example, a user device 302 may be configured with a GPS receiver. In some embodiments, a user device 302 may have a camera, a microphone, a keyboard, and/or other hardware and/or software. The user interface may include application software or program software executable on the user devices 302. In some embodiments, the user interface may be a web-based interface, accessible via an Internet-connected user device 302.

The database 304 may be a remote database, located remotely from the user devices 302. The database 304 may store user data, such as profile and identification data for users of the communication platform. In addition, the database 304 may store message data, including message content, authorship information, access control permissions associated with messages, locations associated with messages, and/or other data for, or associated with, messages. The database 304 may additionally store mapping data in some embodiments, such that a geographic map or map overlay showing streets, addresses, buildings, landmarks, points of interest, geographic features, user locations, and/or available messages may be displayed.

As described above, the communication platform 306 may be accessible via the user devices 302 through a user interface. The communication platform 306 may include hardware and/or software for facilitating location-based communication among users. In some embodiments, the communication platform 306 may include a messaging module 310, a mapping module 312, and an access control module 314. In other embodiments, the communication platform 306 may include additional or alternative modules.

The messaging module 310 may include hardware and/or software for facilitating users' creation of messages, and for maintaining and delivering message content. The messaging module 310 may receive a user's authored message, and content associated with a message. In some embodiments, the messaging module 310 may provide message authoring means for users to create messages. The messaging module 310 may store users' messages in the database 304, such that the messages may be accessed by other users. Additionally, when users access a posted message, the messaging module 310 may display or provide the message content in any suitable form via the user interface.

The messaging module 310 may include hardware, such as for example a controller, processor, hardware circuitry, and/or other hardware components described herein. Hardware circuitry may include receiving hardware circuitry, message creation or message authoring hardware circuitry, message storing hardware circuitry, message accessing or message displaying hardware circuitry, and/or other hardware circuitry. The controller, processer, hardware circuitry, and/or other hardware components may be configured to run or operate one or more software programs or applications for receiving user messages, providing message authoring means for facilitating creation of messages, maintaining message content, and displaying or providing message content. Moreover, in some embodiments, the messaging module 310 may be described as a layer, component, module, or element of a system. Such layer, component, module, or element may include hardware and/or software, as described above, for performing the above-described operations of the messaging module 310.

The mapping module 312 may include hardware and/or software for determining user locations, for maintaining associations between messages and locations, and for presenting location-based information to users. In some embodiments, the mapping module 312 may determine a user's geographic location by, for example, communicating with or accessing location data associated with the user's device, such as GPS data. In other embodiments, the mapping module 312 may receive or determine the user's location using other suitable means or methods. As described above, the mapping module 312 may be configured to determine a user's geographic location continuously, intermittently, occasionally, on demand, or at intervals. The mapping module 312 may additionally present map data to users. For example, the mapping module 312 may display to a user (via the user interface) a map or map overlay of a geographic area. The map or map overlay may include identifications of streets, addresses, buildings, points of interest, landmarks, geographic features, and/or other map data. In some embodiments, the map or map overlay may additionally provide an indication of the user's current location and/or the location of other users. For example, an indicator or icon may illustrate the user's current location on the map or map overlay. Additionally, the mapping module 312 may present indicators or icons representing messages on a map or map overlay. For example, each available or accessible message at or near a user's location may be presented on a map or map overlay with a bubble, circle, or other icon or identifier. The user may have the ability to select, click, or tap a message icon or identifier to access or view message data. In some embodiments, the size of a message icon or identifier may indicate the access area of the message, or the message's popularity, importance, or other properties. As messages are added or removed from a geographic location, the mapping module 312 may update the map or map overlay. In some embodiments, maps or map overlays showing messages may update in real time or near or substantially real time.

The mapping module 312 may include hardware, such as for example a controller, processor, hardware circuitry, and/or other hardware components described herein. Hardware circuitry may include user locating hardware circuitry, map creation hardware circuitry, map displaying hardware circuitry, map updating hardware circuitry, and/or other hardware circuitry. The controller, processer, hardware circuitry, and/or other hardware components may be configured to run or operate one or more software programs or applications for determining or receiving user locations, creating maps or map overlays, updating map data, displaying map data, and displaying map data. Moreover, in some embodiments, the mapping module 312 may be described as a layer, component, module, or element of a system. Such layer, component, module, or element may include hardware and/or software, as described above, for performing the above-described operations of the mapping module 312.

The access control module 314 may include hardware and/or software for controlling users' access to message data. The access control module 314 may provide access control means, whereby a user may control the access area for a message, user permissions, timing, and/or other access control permissions of a message. Based on user inputs and/or default properties, the access control module 314 may additionally be configured to control access to messages. In some embodiments, the access control module 314 may compare user data to access control data for messages to determine if users have permission to access such messages. For example, the access control module 314 may determine, based on user-selected access controls and stored user data, which users have permission to access a particular message. The access control module 314 may communicate with the mapping module 312, such that only users who have access to a particular message may view an icon or identifier for the message on a map or map overlay. Additionally, where timing controls indicate that a message should expire or no longer be available, the access control module 314 may be configured to disable access to a message after such expiration or duration, and may communicate with the mapping module 312, such that an icon or identifier for the message is no longer displayed. Additionally, the access control module 314 may communicate with the messaging module 310 to ensure that message content is displayed only to users who have access to a message.

The access control module 314 may include hardware, such as for example a controller, processor, hardware circuitry, and/or other hardware components described herein. Hardware circuitry may include access permission hardware circuitry, location size hardware circuitry, message timing hardware circuitry, message deletion hardware circuitry, message expiration hardware circuitry, and/or other hardware circuitry. The controller, processer, hardware circuitry, and/or other hardware components may be configured to run or operate one or more software programs or applications for providing access control means, receiving user-defined access controls, implementing access controls, and communicating with the mapping module. Moreover, in some embodiments, the access control module 314 may be described as a layer, component, module, or element of a system. Such layer, component, module, or element may include hardware and/or software, as described above, for performing the above-described operations of the access control module 314.

With continued reference to FIG. 3, the network 308 may include one or more wired or wireless networks, such that the components of the system 300 may communicate using one or more cellular networks, WiFi networks, Bluetooth networks, and/or other wireless or wired networks. In some embodiments, information may pass through more than one network between components. Some components of the system may be directly connected in a direct wired connection or a local area network (LAN) for example. In at least one embodiments, communications to and from user devices 302 may be sent and received via a cellular network, and communication between the database 304 and communication platform 306 may be via a WiFi network or other network.

More generally, the system 300 may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of the system 300 may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

The system 300 may also generally include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. For example, the messaging module 310, mapping module 312, and access control module 314 may be or include programs or applications stored in, and configured to run or execute on, the system 300. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

The system 300 may operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system 300 may be operable to communicate with wired and/or wireless devices or other processing entities using, for example, radio technologies, such as the IEEE 802.xx family of standards, and includes at least WiFi, WiMax, and Bluetooth wireless technologies. Communications can be made via a predefined structure as with a conventional network or via an ad hoc communication between at least two devices.

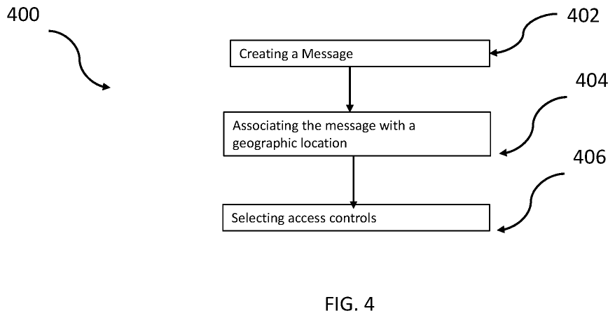

Turning now to FIG. 4, a method 400 of using a communication platform or system of the present disclosure is shown. The method 400 may be performed by a user of the communication platform, by interacting with the platform via a user interface on a user device. The method 400 may generally include the steps of creating a message 402; associating the message with a geographic location 404; and selecting access controls 406. In other embodiments, the method 400 may include additional or alternative steps.

Creating a message 402 may include authoring an original message, which may include text, pictures, video, audio, other attachments, and/or other content. In some embodiments, the message may be created on a user device using the user interface. However, in other embodiments, the message may be created using a different program, application, and/or device.

Via the user interface, the user may associate the message with a geographic location 404. For example, the user may select a location on a map, or may enter an address or point of interest to associate with the message. In some embodiments, the user may associate the message with more than one location. In some embodiments, the user may select or control the size of the location, or the size of a radius in which the message may be made available to other users. In some embodiments, a user may only associate a message at or near the user's current geographic location. Thus, to associate a message with a different geographic location, the user may need to travel. However, in other embodiments, a user may have the ability to associate a message with a geographic location even if the user is not currently at or near that location. It is to be appreciated that by associating a message with a geographic location, the user may effectively “leave” or “drop” the digital message at the location for other users to find.

In some embodiments, the user may select access controls, via the user interface, to determine which users will have permission to view or access the dropped message 406. For example, the user may identify a particular user, group of users, or type of users who may have permission to access the message. For example, the user may identify a particular friend as the only user with the ability to access the message. As another example, the user may identify all of his or her “friends” or contacts as users who may have the ability to access the message. In still another example, the user may set the message as “public,” such that all users may potentially have the ability to access the message. Additionally, the user may select a timing control. For example, the user may select a message duration, during which the message may be accessible at the location, or an expiration time or date, after which the message may no longer be generally accessible at the location. In some embodiments, the user may select or adjust other access controls additionally or alternatively.

In some embodiments, users of a communication platform of the present disclosure may have different use rights. For example, some users may have the option to drop messages at locations remote from the user. Such a user may be an advertiser, for example. Other users may be limited to dropping messages at their current locations. Moreover, different users may have the ability to set or adjust different access controls. For example, some users may have the ability to leave a message for a relatively long duration, or even permanently. Other users may be limited to dropping messages with a relatively short duration. Additionally, while some users may have the ability to leave messages accessible to the public, other users may be limited to leaving more private or limited messages. Additionally, in some embodiments, users may be limited in the number of messages they may drop. For example, a user may be limited to dropping a number of messages per day or per week.

In some embodiments, different use rights may be associated with different subscription services or payment options for the communication platform. For example, some subscription or payment options may allow a user to place one, two, three, or any other suitable number of messages per day or per week. Other subscription or payment options may allow users to only post or place messages associated with particular locations, such as the user's residence for example. Other subscription or payment options may allow a user to post or place messages for access by particular users or groups of users. In some embodiments, users may have the ability to individually purchase messages. The price of posting a message may vary based on the geographic location with which it is associated, number or type of users to whom it is available, or other access controls. In still other embodiments, other subscription or payment options may be used.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A location-based electronic communication method comprising the steps of:
receiving, a digital message and a geographic location or area for the digital message transmitted from a first computer device;
associating the geographic location or area with the digital message;
receiving one or more recipients or group of recipients for the message or a message duration or message expiration;
using the one or more recipients or group of recipients or message duration or expiration for providing the message to a second computer device to display the message on the second computer device when a geographic location or area of the second computer device matches the geographic location or area of the message;
receiving an input notification from the second computer that the message has been accessed or viewed in the geographic location or area associated with the message; and
providing notification to the first computer device that the message has been accessed or viewed.

2. (canceled)

3. The method of claim 1 wherein the geographic location or area for the digital message is determined based upon a GPS location of the first computer device.

4. The method of claim 1, wherein the geographic location or area of the second computer device is determined based upon GPS coordinates of the second computer device.

5. (canceled)

6. (canceled)

7. (canceled)

8. (canceled)

9. A location-based communication application comprising:
an application platform configured to receive an input geographic location and time input from a computer device and access a datastore of digital messages on a non-transitory computer readable media having an associated geographic location or area and expiration or duration; and
a messaging platform including software to provide one or more of the digital messages to the computer device where the associated geographic location or area of the one or more messages matches the input geographic location and where the time input is within the expiration or duration of the messages.

10. (canceled)

11. The application of claim 9, wherein, the messaging platform provides a digital map encompassing the input geographic location including a plurality of icons for the one or more of the digital messages where the associated geographic location or area is within a geographic area of the digital map.

12. (canceled)

13. (canceled)

14. (canceled)

15. (canceled)

16. A location-based communication method comprising the steps of:
receiving time and geographic location inputs from a computer device and utilizing the time and geographic location inputs to access messages in a database having an associated geographic location or area and message duration or expiration; and
using the geographic location and time inputs from the computer device to provide one or more messages to the computer device where the input geographic location matches the associated geographic location or area of the one or more messages and the time input is within the duration or expiration associated with the one or more messages.

17. The method of claim 16, and further comprising providing a digital map of the geographic location or area of the one or more messages.

18. (canceled)

19. (canceled)

20. (canceled)

21. The method of claim 1 wherein the step of providing the message includes providing a push notification of the message to the second computer device.

22. The method of claim 1 wherein the step of receiving the one or more recipients or group of recipients or the message duration or expiration includes receiving both of the one or more recipients or group of recipients and the message duration or expiration and using both the one or more recipients or group of recipients and the message duration or expiration to provide the message to the second computer.

23. The method of claim 1 wherein the step of receiving the one or more recipients or group of recipients or the message duration or expiration includes receiving the one or more recipients or group of recipients and using the one or more recipients or group of recipients to provide the message to the second computer.

24. The method of claim 1 wherein the step of receiving the one or more recipients or group of recipients or the message duration or expiration includes receiving the message duration or expiration and utilizing a time input from the second computer device and the message duration or expiration for providing the message to the second computer device.

25. The method of claim 1 and comprising the step of receiving an input geographic location or area from the first computer device different from a GPS location of the first computer device and associating the input geographic location or area with the digital message.

26. The application of claim 9 wherein the application platform receives an input digital message and associated geographic location or area from another computer device and stores the input digital message and the associated geographic location or area in the datastore.

27. The application of claim 9 wherein the messaging platform receives an input confirmation that the one or more of the digital messages have been accessed or viewed from the computer device and provides confirmation to another computer device of receipt of the input confirmation that the one or more of the digital messages have been accessed or viewed.

28. The application of claim 9 wherein datastore of digital messages includes one or more recipients or group of recipients associated with the digital messages and the messaging platform utilizing the one or more recipients or group of recipients associated with the digital messages to provide the digital messages to the one or more recipients or group of recipients when the input geographic location matches the associated geographic location or area and the time input is within the expiration or duration of the messages.

29. The application of claim 9 wherein the associated geographic location or are and expiration or duration are access control parameters received from another computer device for the digital messages to control access to the digital messages when the input geographic location is located in the geographic location or area associated with the digital messages and the time input is within the expiration or duration of the digital messages.

30. The method of claim 16 and comprising the step of receiving an input message and the associated geographic location or area for the input message and the message duration or expiration from another computer device and storing the input message and the associated geographic location or area and the message duration and expiration in the database.

31. The method of claim 16 and further comprising receiving an input notification that the one or more messages have been accessed or viewed from the computer device and providing an accessed or viewed message notification to another computer device in response to the input notification that the one or more messages have been accessed or viewed.

32. The method of claim 16 and further comprising utilizing one or more recipients or group of recipients associated with the messages to provide the one or more messages to the recipients or groups of recipients when the geographic location input matches the associated geographic location or area and the time input is within the duration or expiration associated with the messages.
